(19) United States
(12) Patent Application Publication
(10) Pub. No.: US 2023/0288051 A1
(43) Pub. Date: Sep. 14, 2023

(54) LED Light Up Pants/Leggings

(71) Applicant: Eniko Szabo, Schaumburg, IL (US)

(72) Inventor: Eniko Szabo, Schaumburg, IL (US)

(21) Appl. No.: 18/099,489

(22) Filed: Jan. 20, 2023

(51) Int. Cl. F21V 33/00; A41D 1/08

(52) U.S. Cl. CPC F21V 33/0008; A41D 1/08; F21Y 2103/10

(57) ABSTRACT

LED Light Up Pants/Leggings for night.

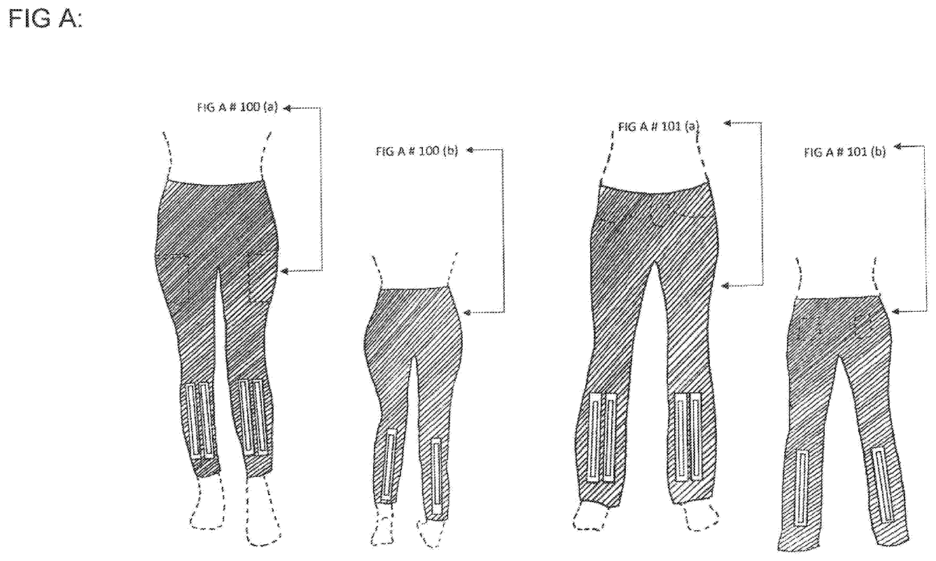

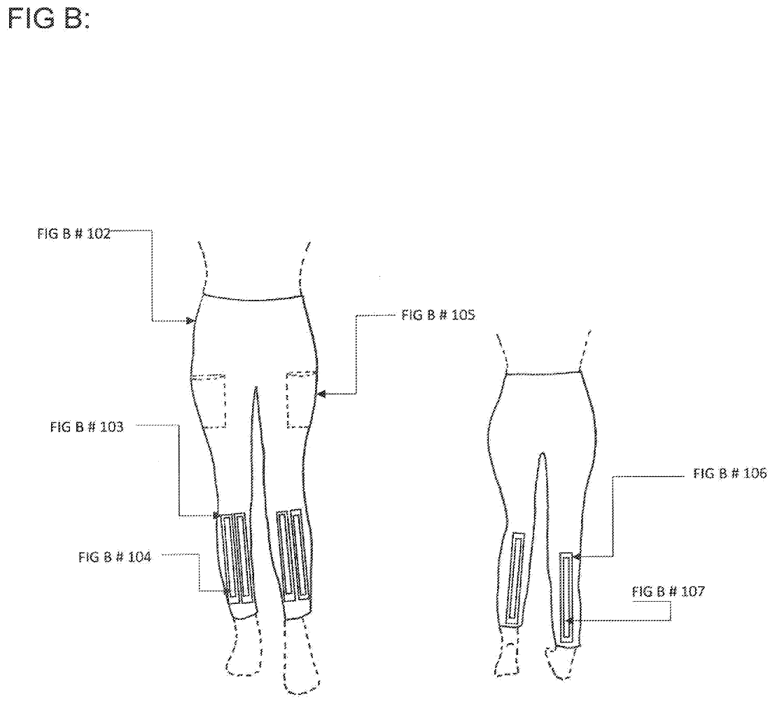

### BRIEF SUMMARY OF THE INVENTION

The present invention LED Light Up Pants/Leggings is part of the collection Led Light Up Socks made from the same inventor (Led Light up Socks/Pull Up/Clip on filed for U.S. patent application Ser. No. 18/097,237 Jan. 14, 2023 title 9123). Led Light Up Pants/Leggings relates generally to exercise and safety in a dark and low visibility environment. More specifically, the present invention relates to a Light Up Gear useful to athletes and general population in the field of running, biking, hiking or leisure walking, fishing in a low visibility environment by providing greater light at the correct angle and height for an easier, hassle free, safer way of training or moving.

### BACKGROUND

This invention Led Lights Up Pants Leggings will remove the hassle of carrying extra devices for luminosity, enhance visibility and won't detached on the move. The LED Light Up Pants/Leggings, invention will provide greater luminosity at the correct angle and height and it's more stable and reduces the hassle of carrying extra device for light. This invention is useful to athletes and general population in the field of Running, Hiking, Biking, Walking, Fishing, Camping. The Led Light Up Pants/leggings will be just an addition to the Led Light Up Socks to give population more variety.

### DETAIL DESCRIPTION OF THE INVENTION

The invention LED Light up Pants/Leggings it relates to a pair of pants/leggings with light up properties. This pair of pants will come in different varieties, color, and cuts.

From straight leg to leggings, from stretching to cotton, for active lifestyle from sports to Leisure.

The LED Light Up Pants/Leggings will be made from the following parts and materials:

A pair of full-length pants/Leggings.

The Led Light Up leggings/pants will be designed for different lifestyle. For runners, bickers, hikers a supper stretchy legging will be available and for leisure walking, hiking, fishing all other activities a straight leg pants from a regular fabric. On the outside of the leggings on the shin part of the leg a waterproof pouch will be sewed on. More Specifically, 2 pouches will be added over the shin on each side of the tibia and 1 pouch in the back over the middle of the. calf.

The pouch will be made from a waterproof material TPU transparent fabric-plastic. This waterproof pouch will be the main holder of the light-strip. The Light Strip will be a Led Light made from soft silicone plastic with individual power button, a mini power bank, a power port for recharge that can be recharged form a power outlet or USB port.

### BRIEF DESCRIPTION OF THE DRAWINGS

Led Light Up Pants/Leggings

FIG. A:

FIG. A shows the front view and the back view of the invention.

FIG. A #100 (a) Shows the front view of the leggings/pants.

FIG. A #100 (b) Shows the back view of the leggings/pants.

FIG. A #101 (a) Shows the front view of the pants.

FIG. A #101 (b) Shows the back view of the pants.

FIG. B:

FIG. B #102 Shows the leggings made from a material.

FIG. B #103 Show the waterproof pouch. The Led Light Holder.

FIG. B #104 Shows the Led Light Strip Inserts.

FIG. B #105 Show the pocket part of item FIG. B #102.

FIG. B #106 Show the back view of the leggings/pants with the waterproof pouch.

FIG. B #107 Shows the Led lights inserts.

### DETAIL DESCRIPTION OF THE DRAWING

The components, details, and the process of making this invention LED Light UP Pants/Leggings

FIG. A: #100 #(a) #101(a) Shows that the invention will come in two different variations straight leg pants or leggings. The invention is a full-length pants/legging. The LED Light Up Pants/Leggings will be made from a combination of nylon, spandex, and cotton materials.

FIG. A: #100 #(b) #101 (b) Shows the back view of the invention.

FIG. B

FIG. B #102 Shows the full length of the Light Up Pants/leggings that will be made from different materials. Form spandex to cotton.

FIG. B #103 A pouch will be added to the items that will hold the Light Strip. The pouch will be made from a TPU transparent fabric/plastic that will be waterproof for preventing the Light Strip to deteriorate from moisture related to weather or body moisture. Each pouch will be sawed on. Two (2) front pouches will be added in the front part of the leg more specifically on both sides of the tibia bone over the shin and one (I) waterproof pouch will be added in the back of the leg over the. calf

FIG. B#104 This is the Led Light Strip insert that will be inserted into the waterproof pouch. Each Insert will be removable for recharge or discard in case of malfunction. The light Strip will be made from soft silicone plastic with individual power on button, a power port for recharge in wall outlet or USB port and will have a mini power bank.

FIG. B: #105 Shows the pocket that is part of item FIG. #102.

FIG. B #106 #107 Show the back of the pants with 1 waterproof pouch and 1 Led Light Inserts over the. calf

1. LED Light Up Pants/Leggings is comprising:
A pants, straight leg, or leggings.
A light holder located within pants.
A light insert.
A full-length pants/legging.
A light in the shin area.
A light over the. calf
A leg covering with lights.
